(19) United States
(12) Patent Application Publication
(10) Pub. No.: US 2012/0169654 A1
(43) Pub. Date: Jul. 5, 2012

(54) TOUCH SENSING APPARATUS

(76) Inventors: Chien-Yu Chan, Hsinchu City (TW); Hung Li, Taipei City (TW)

(21) Appl. No.: 13/293,951

(22) Filed: Nov. 10, 2011

(30) Foreign Application Priority Data
Jan. 4, 2011 (TW) 100100186

(51) Int. Cl. G06F 3/044

(52) U.S. Cl. 345/174

(57) ABSTRACT

A touch sensing apparatus includes a plurality of pins, a logic control module, and at least one driving/sensing module. The driving/sensing control module is coupled with the pins and the logic control module. The driving/sensing control module controls the pins to execute a driving function according to a driving control signal at high voltage level and output a high voltage to a conductive thin film sensor. The driving/sensing control module includes an isolating switch, a high voltage device, and a medium/low voltage device, wherein the isolating switch is coupled with the high voltage device and the medium/low voltage device. The driving/sensing control module activates the isolating switch according to a isolating control signal at high voltage level to isolate the medium/low voltage device from the high voltage device for avoiding the high voltage from entering into the medium/low device that results in the damage of the medium/low voltage device.

### BACKGROUND OF THE INVENTION

1. Field of the Invention

The present invention relates generally to a liquid crystal display; particularly, the present invention relates to a mutual capacitance touch sensing apparatus utilizing the sensing switch component at medium/low voltage level to minimize the space area occupied by the high voltage device and to decrease the cost.

2. Description of the Prior Art

As technology rapidly increases, conventional displays are progressively replaced by thin film transistor liquid crystal displays (TFT LCDs). TFT LCDs are widely used in TVs, flat displays, cell phones, tablet PCs, projectors, and other related electronic devices. For TFT LCDs having touch function, touch sensors play an important role among all other modules, and performance of the touch sensor affects the overall performance of LCD.

Generally, the conventional LCD having mutual capacitance touch sensing function includes a display panel, a conductive thin film sensor (like ITO sensor), and a touch control chip, wherein the conductive thin film sensor includes a plurality of sensing lines and a plurality of driving lines, and the touch control chip includes a plurality of pins. The sensing lines are coupled with the pins respectively. When the driving line transmits a driving pulse to couple a small voltage at the sensing line, the touch control chip will sense the coupled voltage and determine according to the magnitude of the coupled voltage whether the conductive thin film sensor is touched.

Particularly, the pin of the touch sensing apparatus can execute a sensing function or a driving function on the conductive thin film sensor. When the pin executes the sensing function on the sensing line of the conductive thin film sensor, the pin merely utilizes a medium/low voltage. However, when the pin executes the driving function on the driving line of the conductive thin film sensor, the pin needs to output a driving voltage at high voltage level to the driving line of the conductive thin film sensor, resulting in the pin utilizing the high voltage. Since the present touch sensing apparatus does not isolate a sensing switch component from a driving switch component, the conventional sensing switch components are still selected from high-voltage components to avoid that the sensing switch components are damaged by the driving voltage at high voltage level, resulting in the increased cost of the touch sensing apparatus.

Hence, the present invention provides a touch sensing apparatus to minimize the space area occupied by the high voltage device and to decrease the cost.

### SUMMARY OF THE INVENTION

The present invention provides a touch sensing apparatus. In an embodiment, the touch sensing apparatus includes a plurality of pins, a logic control module, and at least one driving/sensing control module. The logic control module generates a driving control signal and an isolating control signal. The at least one driving/sensing control module is coupled with the pins and the logic control module, wherein the driving/sensing control module controls at least one of the pins to execute the driving function according to the driving control signal at high voltage level and output a high voltage to a conductive thin film sensor. The driving/sensing control module includes an isolating switch, a high voltage device, and a medium/low voltage device, wherein the isolating switch is coupled with the high voltage device and the medium/low voltage device.

In practical applications, the touch sensing apparatus further includes a level shifter coupled with the logic control module and the driving/sensing control module, wherein the level shifter converts the isolating control signal at medium/low voltage level outputted from the logic control module into the isolating control signal at high voltage level and transmits the isolating control signal at high voltage level to the driving/sensing control module. The driving/sensing control module activates the isolating switch according to the isolating control signal to isolate the medium/low voltage device from the high voltage device, avoiding the high voltage from entering into the medium/low device.

The logic control module transmits a sensing control signal to the driving/sensing control module, and the driving/sensing control module controls the pins to execute the sensing function according to the sensing control signal at medium/low voltage level for sensing a plurality of analog data through a plurality of sensing lines of the conductive thin film sensor.

Compared to the prior arts, the touch sensing apparatus of the present invention utilizes the logic control module to generate the isolating control signal at medium/low voltage level. The touch sensing apparatus further utilizes the level shifter to convert the isolating control signal at medium/low voltage level into the isolating control signal at high voltage level and transmit the isolating control signal at high voltage level to the driving/sensing control module. The driving/sensing control module controls the isolating switch according to the isolating control signal at high voltage level to isolate the medium/low voltage device from the high voltage device for avoiding the high voltage from entering into the medium/low voltage device. Hence, the touch sensing apparatus of the present invention can utilize the sensing switch component at medium/low voltage level to minimize the space area occupied by the high voltage device, further decreasing the cost of the touch sensing apparatus.

The detailed descriptions and the drawings thereof below provide further understanding about advantage and the spirit of the present invention.

### BRIEF DESCRIPTION OF THE DRAWINGS

FIG. 1 is a schematic view of one embodiment of a touch sensing apparatus for sensing the touch point on a display panel; and

FIG. 2 is a schematic view of the driving/sensing control module of the touch sensing apparatus of the present invention.

### DETAILED DESCRIPTION OF THE PREFERRED EMBODIMENT

One embodiment according to the present invention is a touch sensing apparatus. In the present embodiment, the touch sensing apparatus is a mutual capacitance touch sensing apparatus, but not limited thereto.

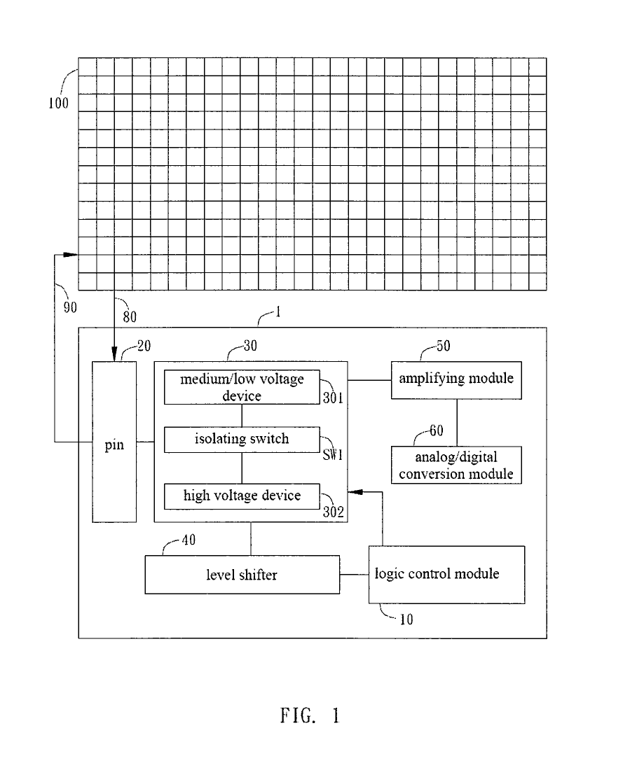

Please refer to FIG. 1. FIG. 1 is a schematic view of a touch sensing apparatus 1 for sensing the touch point on a display panel. As shown in FIG. 1, a liquid crystal display (LCD) panel includes a conductive thin film sensor 100 and the touch sensing apparatus 1. The LCD panel is generally attached below the conductive thin film sensor 100, but the location of the LCD panel is not limited to the embodiment. The touch sensing apparatus 1 includes a logic control module 10, a plurality of pins 20, at least one driving/sensing control module 30, at least one level shifter 40, an amplifying module 50, and an analog/digital conversion module 60. Each driving/sensing control module 30 is coupled with the pins 20 and the amplifying module 50. The level shifter 40 is coupled with the driving/sensing control module 30 and the logic control module 10. The analog/digital conversion module 60 is coupled with the amplifying module 50 and the logic control module 10.

The pins 20 included in the touch sensing apparatus 1 not only have a single function, but can switch between different functions based on practical requirements. For example, these functions include, but are not limited to, driving function, sensing function, ground function, or floating function.

As shown in FIG. 1, the conductive thin film sensor 100 includes a plurality of sensing lines 80 and a plurality of driving lines 90, wherein the driving lines 90 are arranged perpendicular to the sensing lines 80. It is noticed that the driving lines 90 and the sensing lines 80 can be interchanged with each other; in other words, the driving lines 90 shown in FIG. 1 can actually be the sensing lines, and the sensing lines 80 shown in FIG. 1 can actually be the driving lines, wherein the disposition can be controlled by the touch sensing apparatus 1.

It is noted that each driving/sensing control module 30 includes an isolating switch SW1, a medium/low voltage device 301, and a high voltage device 302. The isolating switch SW1 is coupled with the medium/low voltage device 301 and the high voltage device 302. The high voltage device 302 includes a plurality of driving switches, and the driving switches utilize the high voltage. In practical applications, the high voltage utilized in the touch sensing apparatus 1 is larger than 5V, and the medium/low voltage is less than 5V, but there is no limitation to the high voltage and the medium/low voltage.

In the present embodiment, the logic control module 10 generates a driving control signal and an isolating control signal. When the logic control module 10 transmits the driving control signal at medium/low voltage level to the level shifter 40, the level shifter 40 converts the driving control signal at medium/low voltage level into the driving control signal at high voltage level and transmits the driving control signal at high voltage level to the driving/sensing control module 30. The driving/sensing control module 30 controls at least one of the pins 20 to execute the driving function according to the driving control signal at high voltage level and output the high voltage to the driving line 90 of the conductive thin film sensor 100.

When the outputted voltage is at high voltage level, the logic control module 10 will transmit the isolating control signal at medium/low voltage level to the level shifter 40, and the level shifter 40 converts the isolating control signal at medium/low voltage level into the isolating control signal at high voltage level and transmits the isolating control signal at high voltage level to the driving/sensing control module 30. The driving/sensing control module 30 activates (turns on) the isolating switch SW1 according to the isolating control signal at high voltage level to isolate the medium/low voltage device 301 from the high voltage device 302, avoiding the high voltage from entering into the medium/low voltage device 301.

In addition, when the logic control module 10 transmits a sensing control signal at medium/low voltage level to at least one driving/sensing control module 30, each driving/sensing control module 30 will control the pins 20 to execute the sensing function according to the sensing control signal at medium/low voltage level, so that a plurality of analog data can be sensed through the sensing the lines 80 of the conductive thin film sensor 100. As this time, because the high voltage does not pass through the medium/low voltage device 301, it is not necessary to isolate the medium/low voltage device 301 from the high voltage device 302; therefore, the driving/sensing control module 30 can deactivate (turn off) the isolating switch SW1.

The touch sensing apparatus 1 includes the amplifying module 50. The amplifying module 50 amplifies the analog data outputted from the driving/sensing control module 30. When the analog data is transmitted from the conductive thin film sensor 100 to the amplifying module 50 and then is transmitted to the logic control module 10, the conductive thin film sensor 100 will execute a discharge process for avoiding the residual charge of the conductive thin film sensor 100 influences the sensing accuracy of the pins 20.

In the present embodiment, the touch sensing apparatus 1 includes the analog/digital conversion module 60, wherein the analog/digital conversion module 60 converts the amplified analog data into a digital data and transmits the digital data to the logic control module 10. In practice, the amplifying module 50 can be an arbitrary type of amplifier, the analog/digital conversion module 60 can be an arbitrary type of analog/digital converter, and the amplifying module 50 and the analog/digital conversion module 60 are not limited to the embodiment.

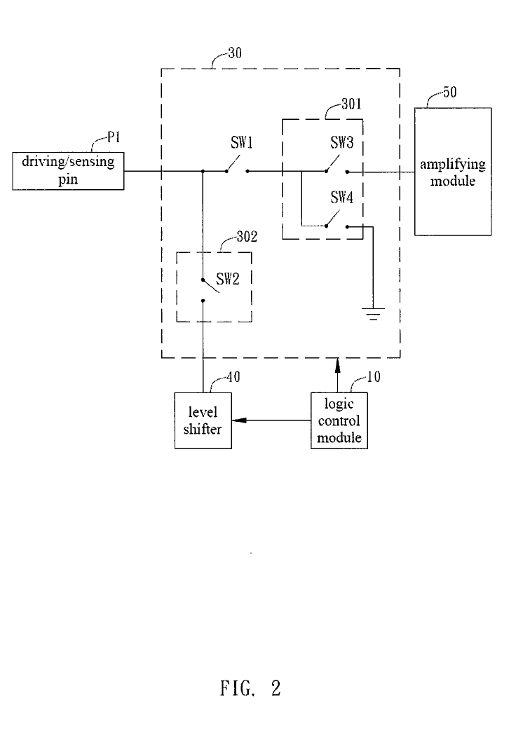

Please refer to FIG. 2. FIG. 2 is a schematic view of one driving/sensing control module 30 of the touch sensing apparatus 1 of the present invention.

As shown in FIG. 2, the driving/sensing control module 30 of the touch sensing apparatus 1 includes the medium/low voltage device 301, the isolating switch SW1, and the high voltage device 302. The isolating switch SW1 is coupled with the medium/low voltage device 301 and the high voltage device 302. The medium/low voltage device 301 includes a sensing switch SW3 and a ground switch SW4. The high voltage device 302 includes a driving switch SW2. The driving switch SW2 is coupled with a driving/sensing pin P1, the isolating switch SW1, and the level shifter 40. The isolating switch SW1 is coupled with the driving/sensing pin P1, the driving switch SW2, the sensing switch SW3, and the ground switch SW4. The sensing switch SW3 is coupled with the isolating switch SW1, the ground switch SW4, and the amplifying module 50. The ground switch SW4 is coupled with the isolating switch SW1, the sensing switch SW3, and a ground end. Besides, the driving/sensing pin P1 is coupled with the isolating switch SW1 and the high voltage device 302.

In a present condition, the isolating switch SW1, the driving switch SW2, the sensing switch SW3, and the ground switch SW4 are all activated, i.e. in activation state.

When the logic control module 10 transmits the driving control signal at medium/low voltage level to the level shifter 40, the driving/sensing control module 30 will control the driving switch SW2 to be deactivated, and the level shifter 40 will convert the driving control signal at medium/low voltage level to the driving control signal at high voltage level and will transmit the driving control signal at high voltage level to the driving/sensing pin P1. The driving/sensing control module 30 controls the driving/sensing pin P1 to execute the sensing function according to the driving control signal at high voltage level and output the high voltage to the driving line 90 of the conductive thin film sensor 100.

In practical applications, the high voltage utilized in the touch sensing apparatus 1 is larger than 5V, but not limited thereto. The level shifter 40 converts the isolating control signal at medium/low voltage level into the isolating control signal at high voltage level, and transmits the isolating control signal at high voltage level to the driving/sensing control module 30. The driving/sensing control module 30 activates the isolating switch SW1 according to the isolating control signal at high voltage level to isolate the medium/low voltage device 301 from the high voltage device 302, avoiding the high voltage from entering into the sensing switch SW3 and the ground switch SW4.

It is noted that, in other embodiments (not shown), each driving/sensing control module includes a plurality of driving switches and a plurality of sensing switches. The driving switches can connect corresponding level shifters, respectively. There is no limitation to the number of the driving switches and the sensing switches.

Compared to the prior arts, the touch sensing apparatus of the present invention utilizes the logic control module to generate the isolating control signal at medium/low voltage level, utilizes the level shifter to convert the isolating control signal at medium/low voltage level into the isolating control signal at high voltage level and transmit the isolating control signal at high voltage level to the driving/sensing control module. The driving/sensing control module controls the isolating switch according to the isolating control signal at high voltage level to isolate the medium/low voltage device from the high voltage device for avoiding the high voltage from entering into the medium/low voltage device. Hence, the touch sensing apparatus of the present invention can utilize the sensing switch component at medium/low voltage level to minimize the space area occupied by the high voltage device, further decreasing the cost of the touch sensing apparatus.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A touch sensing apparatus, comprising:
a plurality of pins;
a logic control module generating a driving control signal and an isolating control signal; and
at least one driving/sensing control module coupled with the pins and the logic control module, the driving/sensing control module controlling at least one of the pins to execute a driving function according to the driving control signal at high voltage level and output a high voltage to a conductive thin film sensor, wherein each driving/sensing control module comprises an isolating switch, a high voltage device, and a medium/low voltage device, the isolating switch is coupled with the high voltage device and the medium/low voltage device, and the driving/sensing control module activates the isolating switch according to the isolating control signal at high voltage level to isolate the medium/low voltage device from the high voltage device for avoiding the high voltage from entering into the medium/low device.

2. The touch sensing apparatus of claim 1, further comprising:
a level shifter coupled with the logic control module and the at least one driving/sensing control module, wherein the level shifter converts the driving control signal at medium/low voltage level and the isolating control signal at medium/low voltage level outputted from the logic control module into the driving control signal at high voltage level and the isolating control signal at high voltage level respectively and transmits the driving control signal at high voltage level and the isolating control signal at high voltage level to the at least one driving/sensing control module.

3. The touch sensing apparatus of claim 1, wherein the high voltage device comprises a plurality of driving switches, and the driving switches utilize the high voltage.

4. The touch sensing apparatus of claim 1, wherein the medium/low voltage device comprises a plurality of sensing switches and a plurality of ground switches, and the sensing switches and the ground switches utilize a medium/low voltage.

5. The touch sensing apparatus of claim 1, wherein the pins also execute a sensing function, a grounding function, or a floating function.

6. The touch sensing apparatus of claim 1, wherein the high voltage is larger than 5V.

7. The touch sensing apparatus of claim 1, wherein the logic control module transmits a sensing control signal to the at least one driving/sensing control module, the at least one driving/sensing control module controls the pins to execute a sensing function according to the sensing control signal for sensing a plurality of analog data through a plurality of sensing lines of the conductive thin film sensor.

8. The touch sensing apparatus of claim 7, further comprising:
an amplifying module coupled with the at least one driving/sensing module, wherein the amplifying module amplifies the analog data outputted from the driving/sensing control module.

9. The touch sensing apparatus of claim 8, further comprising:
an analog/digital conversion module coupled with the amplifying module and the logic control module, wherein the analog/digital conversion module converts the amplified analog data into a digital data and transmits the digital data to the logic control module.

10. The touch sensing apparatus of claim 1, wherein the pin executing the diving function outputs the high voltage to a plurality of driving lines of the conductive thin film sensor.
